(19) United States
(12) Patent Application Publication
(10) Pub. No.: US 2014/0280433 A1
(43) Pub. Date: Sep. 18, 2014

(54) Peer-to-Peer File Distribution for Cloud Environments

(71) Applicant: RACKSPACE US, INC., San Antonio, TX (US)

(72) Inventors: Antony Messerli, San Antonio, TX (US); Paul Voccio, Windcrest, TX (US)

(73) Assignee: Rackspace US, Inc., San Antonio, TX (US)

(21) Appl. No.: 13/803,422

(22) Filed: Mar. 14, 2013

(51) Int. Cl. H04L 29/08

(52) U.S. Cl. CPC H04L 67/06
USPC 709/201

(57) ABSTRACT

A cloud computing system including an image server is disclosed. The image server comprises an endpoint communicatively coupled to a data store, a peer-to-peer endpoint, and a peer-to-peer client. The peer-to-peer endpoint is configured to receive a request for a portion of a data file from a requestor. The image server is configured to determine a location of the portion of the data file within the data store and retrieve the portion of the data file from the data store in response to the request for the portion, and the peer-to-peer client is configured to provide the retrieved portion of the data file to the requestor via the peer-to-peer endpoint. In some examples, the requested data file includes a system image.

### BACKGROUND

The present disclosure relates generally to cloud computing, and more particularly to file distribution and delivery within cloud computing environments.

Cloud computing services can provide computational capacity, data access, networking/routing and storage services via a large pool of shared resources operated by a cloud computing provider. Because the computing resources are delivered over a network, cloud computing is location-independent computing, with all resources being provided to end-users on demand with control of the physical resources separated from control of the computing resources.

Cloud computing is a model for enabling access to a shared collection of computing resources—networks for transfer, servers for storage, and applications or services for completing work. More specifically, the term “cloud computing” describes a consumption and delivery model for IT services based on the Internet, and it typically involves over-the-Internet provisioning of dynamically scalable and often virtualized resources. This frequently takes the form of web-based tools or applications that users can access and use through a web browser as if it was a program installed locally on their own computer. Details are abstracted from consumers, who no longer have need for expertise in, or control over, the technology infrastructure “in the cloud” that supports them. Most cloud computing infrastructures consist of services delivered through common centers and built on servers. Clouds often appear as single points of access for consumers' computing needs, and do not require end-user knowledge of the physical location and configuration of the system that delivers the services.

The utility model of cloud computing is useful because many of the computers in place in data centers today are underutilized in computing power and networking bandwidth. People may briefly need a large amount of computing capacity to complete a computation for example, but may not need the computing power once the computation is done. The cloud computing utility model provides computing resources on an on-demand basis with the flexibility to bring it up or down through automation or with little intervention.

As a result of the utility model of cloud computing, there are a number of aspects of cloud-based systems that can present challenges to existing application infrastructure. First, many cloud systems support self-service, so that users can provision servers and networks with little human intervention. This requires considerable infrastructure planning, resource management, and activity monitoring. Second, robust network access is necessary. Because computational resources are delivered over the network, the individual service endpoints need to be network-addressable over standard protocols and through standardized mechanisms. Third, cloud systems typically support multi-tenancy. Clouds are designed to serve multiple consumers according to demand, and it is important that resources be shared fairly and that individual users not suffer performance degradation. Fourth, cloud systems possess elasticity. Clouds are designed for rapid creation and destruction of computing resources, typically based upon virtual containers. These different types of resources are deployed rapidly and scale up or down based on need. Accordingly, the cloud and the applications that employ the cloud must be prepared for impermanent, fungible resources. Application states and cloud states must be explicitly managed because there is no guaranteed permanence of the infrastructure. Fifth, clouds typically provide metered or measured service. Like utilities that are paid for by the hour, clouds should optimize resource use and control it for the level of service or type of servers such as storage or processing.

Cloud computing offers different service models depending on the capabilities a consumer may require, including SaaS, PaaS, and IaaS-style clouds. SaaS (Software as a Service) clouds provide the users the ability to use software over the network and on a distributed basis. SaaS clouds typically do not expose any of the underlying cloud infrastructure to the user. PaaS (Platform as a Service) clouds provide users the ability to deploy applications through a programming language or tools supported by the cloud platform provider. Users interact with the cloud through standardized APIs, but the actual cloud mechanisms are abstracted away. Finally, IaaS (Infrastructure as a Service) clouds provide computer resources that mimic physical resources, such as computer instances, network connections, and storage devices. The actual scaling of the instances may be hidden from the developer, but users are required to control the scaling infrastructure.

Because the flow of services provided by the cloud is not directly under the control of the cloud computing provider, cloud computing requires the rapid and dynamic creation and destruction of computational units, frequently realized as virtualized resources. Maintaining the reliable flow and delivery of dynamically changing computational resources on top of a pool of limited and less-reliable physical servers provides unique challenges. Accordingly, it is desirable to provide a better-functioning cloud computing system with superior operational capabilities.

In particular, the rapid and dynamic creation and destruction of computational units may require careful management of system images, sets of files need to “boot” a virtual machine. The more heterogeneous and diverse the cloud deployment, the more system images may be required. Accordingly, greater resources may be required to maintain and deliver the images. As system images tend to be large, the impact of image distribution on network traffic can be substantial. Time spent waiting for the image to be delivered is time that cannot be devoted to running user tasks. Thus, techniques of rapidly deploying system without hindering network performance have the potential to greatly improve cloud performance and user experience.

### BRIEF DESCRIPTION OF THE DRAWINGS

FIG. 1 is a schematic view illustrating an external view of a cloud computing system according to various embodiments.

FIG. 2 is a schematic view illustrating an information processing system as used in various embodiments.

FIG. 3 is a network operating environment for a cloud controller or cloud service according to various embodiments.

FIG. 4 is a schematic view illustrating management of system images in a computing environment as used in various embodiments.

FIG. 5 is a functional block diagram of a virtual machine image service according to various aspects of the current disclosure.

FIG. 6 is a functional block diagram of a peer-to-peer image service according to various aspects of the current disclosure.

FIG. 7 is a flowchart showing a method of providing of an image based on a request received from a client according to various aspects of the current disclosure.

FIG. 8 is a flowchart showing a method of providing of a portion of a file as a virtual seed according to various aspects of the current disclosure.

FIG. 9 is a flowchart showing a method of preloading a file such as an image according to various aspects of the current disclosure.

### SUMMARY OF THE INVENTION

In one embodiment, an image server comprises a peer-to-peer client, a peer-to-peer endpoint, and an endpoint communicatively coupled to a data store. The peer-to-peer endpoint is configured to receive a request for a portion of a data file from a requestor. The image server is configured to determine a location of the portion of the data file within the data store and retrieve the portion of the data file from the data store in response to the request for the portion. The peer-to-peer client is configured to provide the retrieved portion of the data file to the requestor via the peer-to-peer endpoint. The image server may also comprise a server-side cache, and the image server may be configured to, in the determining of the location of the portion of the data file, determine the location of the portion within the data store and the server-side cache.

In another embodiment, a method for providing a data file comprises: receiving a request for a portion of a data file from a requestor; determining a location of the portion of the data file on a data store in response to the received request; determining an interface for accessing the portion of the data file; retrieving the portion of the data file using the interface; and providing the portion of the data file to the requestor via a peer-to-peer interface. The determining of the interface may include determining one of a first interface communicatively coupled with a first storage the data store and a second interface communicatively coupled with a second storage of the data store, where the first interface is different from the second.

In another embodiment, a method for preloading a data file comprises: determining, by a providing server, a data file to provide via a peer-to-peer interface; determining a time to provide the data file to a receiving system, the time being prior to the receiving system initiating a transfer of the data file; and providing, by the providing server, the data file to a receiving system at the determined time via the peer-to-peer interface. The method may further comprise determining a cache status of the receiving system, and the determining of the data file may be based on the cache status of the receiving system.

### DETAILED DESCRIPTION

The following disclosure has reference to peer-to-peer delivery of files in a distributed computing environment such as a cloud architecture.

Referring now to FIG. 1, an external view of one embodiment of a cloud computing system 110 is illustrated. The cloud computing system 110 includes a user device 102 connected to a network 104 such as, for example, a Transport Control Protocol/Internet Protocol (TCP/IP) network (e.g., the Internet). The user device 102 is coupled to the cloud computing system 110 via one or more service endpoints 112. Depending on the type of cloud service provided, these endpoints give varying amounts of control relative to the provisioning of resources within the cloud computing system 110. For example, SaaS endpoint 112a will typically only give information and access relative to the application running on the cloud storage system, and the scaling and processing aspects of the cloud computing system will be obscured from the user. PaaS endpoint 112b will typically give an abstract Application Programming Interface (API) that allows developers to declaratively request or command the backend storage, computation, and scaling resources provided by the cloud, without giving exact control to the user. IaaS endpoint 112c will typically provide the ability to directly request the provisioning of resources, such as computation units (typically virtual machines), software-defined or software-controlled network elements like routers, switches, domain name servers, etc., file or object storage facilities, authorization services, database services, queue services and endpoints, etc. In addition, users interacting with an IaaS cloud are typically able to provide virtual machine images that have been customized for user-specific functions. This allows the cloud computing system 110 to be used for new, user-defined services without requiring specific support.

It is important to recognize that the control allowed via an IaaS endpoint is not complete. Within the cloud computing system 110 are one or more cloud controllers 120 (running what is sometimes called a “cloud operating system”) that work on an even lower level, interacting with physical machines, managing the occasionally contradictory demands of the multi-tenant cloud computing system 110. The workings of the cloud controllers 120 are typically not exposed outside of the cloud computing system 110, even in an IaaS context. In one embodiment, the commands received through one of the service endpoints 112 are then routed via one or more internal networks 114. The internal network 114 couples the different services to each other. The internal network 114 may encompass various protocols or services, including but not limited to electrical, optical, or wireless connections at the physical layer; Ethernet, Fibre channel, ATM, and SONET at the MAC layer; TCP, UDP, ZeroMQ or other services at the connection layer; and XMPP, HTTP, AMPQ, STOMP, SMS, SMTP, SNMP, or other standards at the protocol layer. The internal network 114 is typically not exposed outside the cloud computing system, except to the extent that one or more virtual networks 116 may be exposed that control the internal routing according to various rules. The virtual networks 116 typically do not expose as much complexity as may exist in the actual internal network 114; but varying levels of granularity can be exposed to the control of the user, particularly in IaaS services.

In one or more embodiments, it may be useful to include various processing or routing nodes in the network layers 114 and 116, such as proxy/gateway 118. Other types of processing or routing nodes may include switches, routers, switch fabrics, caches, format modifiers, or correlators. These processing and routing nodes may or may not be visible to the outside. It is typical that one level of processing or routing nodes may be internal only, coupled to the internal network 114, whereas other types of network services may be defined by or accessible to users, and show up in one or more virtual networks 116. Either of the internal network 114 or the virtual networks 116 may be encrypted or authenticated according to the protocols and services described below.

In various embodiments, one or more parts of the cloud computing system 110 may be disposed on a single host. Accordingly, some of the “network” layers 114 and 116 may be composed of an internal call graph, inter-process communication (IPC), or a shared memory communication system.

Once a communication passes from the endpoints via a network layer 114 or 116, as well as possibly via one or more switches or processing devices 118, it is received by one or more applicable cloud controllers 120. The cloud controllers 120 are responsible for interpreting the message and coordinating the performance of the necessary corresponding services, returning a response if necessary. Although the cloud controllers 120 may provide services directly, more typically the cloud controllers 120 are in operative contact with the service resources 130 necessary to provide the corresponding services. For example, it is possible for different services to be provided at different levels of abstraction. For example, a “compute” service 130a may work at an IaaS level, allowing the creation and control of user-defined virtual computing resources. In the same cloud computing system 110, a PaaS-level object storage service 130b may provide a declarative storage API, and a SaaS-level Queue service 130c, DNS service 130d, or Database service 130e may provide application services without exposing any of the underlying scaling or computational resources. Other services are contemplated as discussed in detail below.

In various embodiments, various cloud computing services or the cloud computing system itself may include a message passing system. A message routing service 140 may be used to address this need. For example, in one embodiment, the message routing service 140 is used to transfer messages from one component to another without explicitly linking the state of the two components. Note that this message routing service 140 may or may not be available for user-addressable systems. In one preferred embodiment, there is a separation between storage for cloud service state and for user data, including user service state. Furthermore, the message routing service 140 is not a required part of the system architecture, and is not present in at least one embodiment.

In various embodiments, various cloud computing services or the cloud computing system itself may include a persistent storage for storing a system state. A data store 150 is available to address this need, but it is not a required part of the system architecture in at least one embodiment. In one embodiment, various aspects of system state are saved in redundant databases on various hosts or as special files in an object storage service. In a second embodiment, a relational database service is used to store system state. In a third embodiment, a column, graph, or document-oriented database is used. Note that this persistent storage may or may not be available for user-addressable systems. In one preferred embodiment, there is a separation between storage for cloud service state and for user data, including user service state.

In various embodiments, it may be useful for the cloud computing system 110 to have a system controller 160. In one embodiment, the system controller 160 is similar to the cloud computing controllers 120, except that it is used to control or direct operations at the level of the cloud computing system 110 rather than at the level of an individual service.

For clarity of discussion above, only one user device 102 has been illustrated as connected to the cloud computing system 110. One of skill in the art will recognize, however, that a plurality of user devices 102 may, and typically will, be connected to the cloud computing system 110 and that each element or set of elements within the cloud computing system is replicable as necessary. Further, the cloud computing system 110, whether or not it has one endpoint or multiple endpoints, is expected to encompass embodiments including public clouds, private clouds, hybrid clouds, and multi-vendor clouds. Likewise for clarity, the discussion generally referred to receiving a communication from outside the cloud computing system, routing it to a cloud controller 120, and coordinating processing of the message via a service 130. Furthermore, the infrastructure described is also equally available for sending out messages. These messages may be sent out as replies to previous communications, or they may be internally sourced. Routing messages from a particular service 130 to a user device 102 is accomplished in the same manner as receiving a message from user device 102 to a service 130, just in reverse.

Each of the user device 102, the cloud computing system 110, the endpoints 112, the network switches and processing nodes 118, the cloud controllers 120 and the cloud services 130 typically include a respective information processing system, a subsystem, or a part of a subsystem for executing processes and performing operations (e.g., processing or communicating information). An information processing system is an electronic device capable of processing, executing or otherwise handling information, such as a computer. FIG. 2 shows an information processing system 210 that is representative of one of, or a portion of, the information processing systems described above.

Referring now to FIG. 2, diagram 200 shows an information processing system 210 configured to host one or more virtual machines, coupled to a network 205. The network 205 could be one or both of the networks 114 and 116 described above. An information processing system is an electronic device capable of processing, executing or otherwise handling information. Examples of information processing systems include a server computer, a personal computer (e.g., a desktop computer or a portable computer such as, for example, a laptop computer), a handheld computer, and/or a variety of other information handling systems known in the art. The information processing system 210 shown is representative of, one of, or a portion of, the information processing systems described above.

The information processing system 210 may include any or all of the following: (a) a processor 212 for executing and otherwise processing instructions, (b) one or more network interfaces 214 (e.g., circuitry) for communicating between the processor 212 and other devices, those other devices possibly located across the network 205; (c) a memory device 216 (e.g., FLASH memory, a random access memory (RAM) device or a read-only memory (ROM) device for storing information (e.g., instructions executed by processor 212 and data operated upon by processor 212 in response to such instructions)). In some embodiments, the information processing system 210 may also include a separate computer-readable medium 218 operably coupled to the processor 212 for storing information and instructions as described further below.

In one embodiment, there is more than one network interface 214 so that the multiple network interfaces can be used to separately route management, production, and other traffic. In one exemplary embodiment, an information processing system has a “management” interface at 1 GB/s, a “production” interface at 10 GB/s, and may have additional interfaces for channel bonding, high availability, or performance. An information processing device configured as a processing or routing node may also have an additional interface dedicated to public Internet traffic, and specific circuitry or resources necessary to act as a VLAN trunk.

In some embodiments, the information processing system 210 may include a plurality of input/output devices 220a-n, the devices of which are operably coupled to the processor 212, for inputting or outputting information, such as a display device 220a, a print device 220b, or other electronic circuitry 220c-n for performing other operations of the information processing system 210 known in the art.

With reference to the computer-readable media, including both memory device 216 and secondary computer-readable medium 218, the computer-readable media and the processor 212 are structurally and functionally interrelated with one another as described below in further detail, and the information processing system of the illustrative embodiment is structurally and functionally interrelated with a respective computer-readable medium similar to the manner in which the processor 212 is structurally and functionally interrelated with the computer-readable media 216 and 218. As discussed above, the computer-readable media may be implemented using a hard disk drive, a memory device, and/or a variety of other computer-readable media known in the art, and when including functional descriptive material, data structures are created that define structural and functional interrelationships between such data structures and the computer-readable media (and other aspects of the system 200). Such interrelationships permit the data structures' functionality to be realized. For example, in one embodiment the processor 212 reads (e.g., accesses or copies) such functional descriptive material from the network interface 214, the computer-readable media 218 onto the memory device 216 of the information processing system 210, and the information processing system 210 (more particularly, the processor 212) performs its operations, as described elsewhere herein, in response to such material stored in the memory device of the information processing system 210. In addition to reading such functional descriptive material from the computer-readable medium 218, the processor 212 is capable of reading such functional descriptive material from (or through) the network 105. In one embodiment, the information processing system 210 includes at least one type of computer-readable media that is non-transitory. For explanatory purposes below, singular forms such as “computer-readable medium,” “memory,” and “disk” are used, but it is intended that these may refer to all or any portion of the computer-readable media available in or to a particular information processing system 210, without limiting them to a specific location or implementation.

The information processing system 210 includes a hypervisor 230. The hypervisor 230 may be implemented in software, as a subsidiary information processing system, or in a tailored electrical circuit or as software instructions to be used in conjunction with a processor to create a hardware-software combination that implements the specific functionality described herein. To the extent that software is used to implement the hypervisor, it may include software that is stored on a computer-readable medium, including the computer-readable medium 218. The hypervisor may be included logically “below” a host operating system, as a host itself, as part of a larger host operating system, or as a program or process running “above” or “on top of” a host operating system. Examples of hypervisors include Xenserver, KVM, VMware, Microsoft's Hyper-V, and emulation programs such as QEMU.

The hypervisor 230 includes the functionality to add, remove, and modify a number of logical containers 232a-n associated with or assigned to the hypervisor. Zero, one, or many of the logical containers 232a-n contain associated operating environments 234a-n. The logical containers 232a-n can implement various interfaces depending upon the desired characteristics of the operating environment. The interfaces may be virtual representations of dedicated hardware, and thus, the logical container may appear to be a stand-alone computing system. For example, in one embodiment, a logical container 232 implements a hardware-like interface, such that the associated operating environment 234 appears to be running on or within an information processing system such as the information processing system 210. For example, one embodiment of a logical container 234 could implement an interface resembling an x86, x86-64, ARM, or other computer instruction set with appropriate RAM, busses, disks, and network devices. The virtual hardware could appear to run any suitable operating environment 234 including an operating system such as Microsoft Windows, Linux, Linux-Android, or Mac OS X. In another embodiment, a logical container 232 implements an operating system-like interface, such that the associated operating environment 234 appears to be running on or within an operating system. For example one embodiment of this type of logical container 232 could appear to be a Microsoft Windows, Linux, or Mac OS X operating system. Other possible operating systems includes an Android operating system, which includes significant runtime functionality on top of a lower-level kernel. A corresponding operating environment 234 could enforce separation between users and processes such that each process or group of processes appeared to have sole access to the resources of the operating system. In a third environment, a logical container 232 implements a software-defined interface, such a language runtime or logical process that the associated operating environment 234 can use to run and interact with its environment. For example, one embodiment of this type of logical container 232 could appear to be a Java, Dalvik, Lua, Python, or other language virtual machine. A corresponding operating environment 234 would use the built-in threading, processing, and code loading capabilities to load and run code. Adding, removing, or modifying a logical container 232 may or may not also involve adding, removing, or modifying an associated operating environment 234. For ease of explanation below, these operating environments 234 will be described in terms of an embodiment as “Virtual Machines,” or “VMs,” but this is simply one implementation among the options listed above.

In one or more embodiments, a VM has one or more virtual network interfaces 236. How the virtual network interface is exposed to the operating environment depends upon the implementation of the operating environment. In an operating environment that mimics a hardware computer, the virtual network interface 236 appears as one or more virtual network interface cards. In an operating environment that appears as an operating system, the virtual network interface 236 appears as a virtual character device or socket. In an operating environment that appears as a language runtime, the virtual network interface appears as a socket, queue, message service, or other appropriate construct. The virtual network interfaces (VNIs) 236 may be associated with a virtual switch (Vswitch) at either the hypervisor or container level. The VNI 236 logically couples the operating environment 234 to the network, and allows the VMs to send and receive network traffic. In one embodiment, the physical network interface card 214 is also coupled to one or more VMs through a Vswitch.

In one or more embodiments, each VM includes identification data for use naming, interacting, or referring to the VM. This can include the Media Access Control (MAC) address, the Internet Protocol (IP) address, and one or more unambiguous names or identifiers.

In one or more embodiments, a “volume” is a detachable block storage device. In some embodiments, a particular volume can only be attached to one instance at a time, whereas in other embodiments a volume works like a Storage Area Network (SAN) so that it can be concurrently accessed by multiple devices. Volumes can be attached to either a particular information processing device or a particular virtual machine, so they are or appear to be local to that machine. Further, a volume attached to one information processing device or VM can be exported over the network to share access with other instances using common file sharing protocols. In other embodiments, there are areas of storage declared to be “local storage.” Typically a local storage volume will be storage from the information processing device shared with or exposed to one or more operating environments on the information processing device. Local storage is guaranteed to exist only for the duration of the operating environment; recreating the operating environment may or may not remove or erase any local storage associated with that operating environment.

Turning now to FIG. 3, a simple network operating environment 300 for a cloud controller or cloud service is shown. The network operating environment 300 includes multiple information processing systems 310a-n, each of which correspond to a single information processing system 210 as described relative to FIG. 2, including a hypervisor 230, zero or more logical containers 232 and zero or more operating environments 234. The information processing systems 310a-n are connected via a communication medium 312, typically implemented using a known network protocol such as Ethernet, Fibre Channel, Infiniband, or IEEE 1394. For ease of explanation, the network operating environment 300 will be referred to as a “cluster,” “group,” or “zone” of operating environments. The cluster may also include a cluster monitor 314 and a network routing element 316. The cluster monitor 314 and network routing element 316 may be implemented as hardware, as software running on hardware, or may be implemented completely as software. In one implementation, one or both of the cluster monitor 314 or network routing element 316 is implemented in a logical container 232 using an operating environment 234 as described above. In another embodiment, one or both of the cluster monitor 314 or network routing element 316 is implemented so that the cluster corresponds to a group of physically co-located information processing systems, such as in a rack, row, or group of physical machines.

The cluster monitor 314 provides an interface to the cluster in general, and provides a single point of contact allowing someone outside the system to query and control any one of the information processing systems 310, the logical containers 232 and the operating environments 234. In one embodiment, the cluster monitor also provides monitoring and reporting capabilities.

The network routing element 316 allows the information processing systems 310, the logical containers 232 and the operating environments 234 to be connected together in a network topology. The illustrated tree topology is only one possible topology; the information processing systems and operating environments can be logically arrayed in a ring, in a star, in a graph, or in multiple logical arrangements through the use of vLANs.

In one embodiment, the cluster also includes a cluster controller 318. The cluster controller is outside the cluster, and is used to store or provide identifying information associated with the different addressable elements in the cluster—specifically the cluster generally (addressable as the cluster monitor 314), the cluster network router (addressable as the network routing element 316), each information processing system 310, and with each information processing system the associated logical containers 232 and operating environments 234. The cluster controller 318 may include a registry of VM information 319. In alternate embodiments, the registry 319 is associated with but not included in the cluster controller 318.

In one embodiment, the cluster also includes one or more instruction processors 320. In the embodiment shown, the instruction processor is located in the hypervisor, but it is also contemplated to locate an instruction processor within an active VM or at a cluster level, for example in a piece of machinery associated with a rack or cluster. In one embodiment, the instruction processor 320 is implemented in a tailored electrical circuit or as software instructions to be used in conjunction with a physical or virtual processor to create a hardware-software combination that implements the specific functionality described herein. To the extent that one embodiment includes computer-executable instructions, those instructions may include software that is stored on a computer-readable medium. Further, one or more embodiments have associated with them a buffer 322. The buffer 322 can take the form of data structures, a memory, a computer-readable medium, or an off-script-processor facility. For example, one embodiment uses a language runtime as an instruction processor 320. The language runtime can be run directly on top of the hypervisor, as a process in an active operating environment, or can be run from a low-power embedded processor. In a second embodiment, the instruction processor 320 takes the form of a series of interoperating but discrete components, some or all of which may be implemented as software programs. For example, in this embodiment, an interoperating bash shell, gzip program, an rsync program, and a cryptographic accelerator chip are all components that may be used in an instruction processor 320. In another embodiment, the instruction processor 320 is a discrete component, using a small amount of flash and a low power processor, such as a low-power ARM processor. This hardware-based instruction processor can be embedded on a network interface card, built into the hardware of a rack, or provided as an add-on to the physical chips associated with an information processing system 310. It is expected that in many embodiments, the instruction processor 320 will have an integrated battery and will be able to spend an extended period of time without drawing current. Various embodiments also contemplate the use of an embedded Linux or Linux-Android environment.

FIG. 4 is a schematic view illustrating management of system images in a computing environment 400 as used in various embodiments. Information processing system 410 may be representative of any of a single information processing device 210 as described relative to FIG. 2, multiple information processing devices 210, and/or a group or cluster of information processing devices 310 as described relative to FIG. 3. In that regard, the information processing system 410 may include a hypervisor 230. In various embodiments, the hypervisor 230 is a combination of hardware circuits and/or software instructions that adds, removes, or modifies a number of associated logical containers 232 (including illustrated containers 232a-n) and virtual machines 234 (including illustrated virtual machines 234a-n). To the extent that software is used to implement the hypervisor 230, it may include software that is stored on a computer-readable medium. The hypervisor 230 may be included logically “below” a host operating system, as a host itself, as part of a larger host operating system, or as a program or process running “above” or “on top of” a host operating system. Examples of hypervisors 230 include Xenserver, KVM, VMware, Microsoft's Hyper-V, and emulation programs such as QEMU.

In initializing a virtual machine, a request is made for a system image for the VM. A system image is a file or set of files that enables a virtual machine to “boot,” to drive an interface, to access local and networked resources, and/or to perform other computing tasks. In various embodiments, the system image includes device drivers, operating system components, runtime libraries, software programs, and/or other software elements. In some related embodiments, the system image includes information such as metadata about the underlying virtual machine. A system image may also include system state information that describes a starting state for the VM. A disk image is a particular type of system image that also contains file locations. The file locations correspond to block addresses on a physical or virtual storage device where a portion of a file is ostensibly “stored.” For the purposes of this disclosure, the terms “disk image” and “system image” are used interchangeably and encompass both disk images and system images. Exemplary formats for system images include: raw, VHD (virtual hard disk), VMDK (virtual machine disk), VDI (virtual desktop infrastructure/interface), iso, qcow, Amazon kernel image, Amazon ramdisk image, and Amazon machine image.

Returning to the example, the request for a system image may come, in part or in whole, from the information processing system 410, a scheduler 402 associated with the information processing system 410, and/or a compute controller 404 associated with the information processing system 410, as well as from other sources such as a user interface. In some embodiments, the request directly identifies a specific image. In alternate embodiments, the request contains information used to determine the image to be provided. For example, the request may contain information regarding the underlying hardware of the information processing system 410, hardware to be emulated on the virtual machine, resources to be allocated to the virtual machine, resources to be accessible by the virtual machine, applications to be run on the virtual machine, and/or the identity, class, or permissions of the user requesting the virtual machine. This list is merely exemplary, and, in further embodiments, the image request provides other relevant data. An image service client 406 of the information processing system 410 may determine a corresponding system image from such a request or may forward the request (with or without supplying additional identifying information) to an image server 408, such as a Glance API server, to determine the corresponding system image. The image server 408 is discussed in further detail with reference to FIG. 5.

Once the identity of the image has been determined, the image is provided to the hypervisor 230. In some embodiments, the information processing system 410 includes a local image cache 412, which may contain one or more cached images 414a-n. If the requested image is among the cached images 414a-n, the requested image may be provided to the hypervisor from the local image cache 412. If the requested image is not among the cached images 414a-n and/or if the system 410 lacks a local image cache 412, the image may be requested from the image server 408 via a network interface 214.

The image service client 406 and/or image server 408 provide a robust image delivery system whereby multiple images can be provided across a cloud system 100. These multiple images may correspond to different operating systems, different release versions, different virtual hardware emulation, different functionality, and/or other differing operating conditions and parameters. For example, in an embodiment, the image server 408 maintains a version 1.1 release of a Linux-based operating system, a version 2.0 release of the same Linux-based operating system, and release of a Microsoft Windows-based operating system. In many embodiments, this allows for the creation and concurrent operation of virtual machines using any of the supported images.

As another benefit, by handling image requests through the image service client 406, in some embodiments, the requestor remains agnostic as to the actual composition of the image. For example, in some embodiments, a new version of an image may be rolled out by notifying the image service client 406 and/or the image server 408 without notifying, modifying, or updating either the scheduler 402 or the compute controller 404. The architecture may also insulate the requestor from changes to or interruptions of the image server. In some exemplary embodiments, the resources of, for example, the image server 408 may be upgraded, thereby changing the physical hardware that provides the image. This need not require updating or even notifying the requestor of the change. This abstraction is particularly advantageous in a dynamic environment such as a cloud environment where computing resources including data storage and computing power are routinely added, removed, duplicated, and otherwise modified to accommodate fluctuations in demand.

Furthermore, in some embodiments, the architecture is configured to support data reuse. For example, in an embodiment, the image service client 406 retains a single copy of a system image in the local image cache 412 and supplies the single copy to multiple VMs instead of maintaining a unique copies for each VM. This data reuse may reduce the number of network transactions by eliminating duplicate requests to retrieve identical copies. In turn, serving a single image to multiple VMs of a single information processing system 410 may relieve network burden and resource demand on the image service client 406 and the image server 408.

FIG. 5 is a functional block diagram of a virtual machine (VM) image service 500 according to various aspects of the current disclosure. Generally, the VM image service 500 is an IaaS-style cloud computing system for registering, storing, and retrieving virtual machine images and associated metadata. In a preferred embodiment, the VM image service 500 is deployed as a service resource 130 in the cloud computing system 110 (FIG. 1). The service 500 presents an endpoint for clients of the cloud computing system 110 to store, lookup, and retrieve system images on demand.

As shown in the illustrated embodiment of FIG. 5, the VM image service 500 comprises a component-based architecture that may include an image server 408, a data store 502, and a registry store 504. The image server 408 is a communication hub that routes system image requests and data between clients 510a-n, the data store 502, and the registry store 504. The image server 408 may be implemented in software or in a tailored electrical circuit or as software instructions to be used in conjunction with a processor to create a hardware-software combination that implements the specific functionality described herein. To the extent that software is used to implement the image server 408, it may include software that is stored on a non-transitory computer-readable medium in an information processing system, such as the information processing system 210 of FIG. 2.

The image server 408 provides data to the clients 510 (including clients 510a-n). Examples of clients 510 include information processing systems 410 as described relative to FIG. 4 including associated schedulers 402 and/or compute controllers 404, as well as other computing devices including server computers, personal computers, portable computers, computers, thin client devices, computing appliances, embedded systems, and other computer processing systems known in the art. In the illustrated embodiment, the image server 408 includes an “external” API endpoint 506 through which the clients 510-n may programmatically access system images managed by the service 500. In that regard, the API endpoint 506 exposes both metadata about managed system images and the image data itself to requesting clients. In one embodiment, the API endpoint 506 is implemented with an RPC-style system, such as CORBA, DCE/COM, SOAP, or XML-RPC, and adheres to the calling structure and conventions defined by these respective standards. In another embodiment, the external API endpoint 506 is a basic HTTP web service adhering to a representational state transfer (REST) style and may be identifiable via a URL. Specific functionality of the API endpoint 506 will be described in greater detail below.

In some embodiments, the image server 408 may include a server-side image cache 516 that temporarily stores system image data to be provided to the clients 510. In such a scenario, if a client 510 requests a system image that is held in the server image cache 516, the API server can distribute the system image to the client without having to retrieve the image from the data store 502. Locally caching system images on the API server not only decreases response time but it also enhances the scalability of the VM image service 500. For example, in one embodiment, the image service 500 may include a plurality of API servers, where each may cache the same system image and simultaneously distribute portions of the image to a client.

When the image server 408 cannot satisfy a client request via the server-side image cache 516, the server 408 may access the data store 502. The data store 502 is an autonomous and extensible storage resource that stores system images managed by the service 500. In the illustrated embodiment, the data store 502 is any local or remote storage resource that is programmatically accessible by an “internal” API endpoint within the image server 408. In one embodiment, the data store 502 may simply be a file system storage 512a that is physically associated with the image server 408. In such an embodiment, the image server 408 includes a file system API endpoint 514a that communicates natively with the file system storage 512a. The file system API endpoint 514a conforms to a standardized storage API for reading, writing, and deleting system image data. Thus, when a client 510 requests a system image that is stored in the file system storage 512a, the image server 408 makes an internal API call to the file system API endpoint 514a, which, in turn, sends a read command to the file system storage 512a. In other embodiments, the data store 502 may be implemented with AMAZON S3 storage 512b, SWIFT storage 512c, and/or HTTP storage 512n that are respectively associated with an S3 endpoint 514b, SWIFT endpoint 514c, and HTTP endpoint 514n on the image server 408. In one embodiment, the HTTP storage 512n may comprise a URL that points to a virtual machine image hosted somewhere on the Internet and may be read-only. It is understood that any number of additional storage resources, such as Sheepdog, a Rados block device (RBD), a storage area network (SAN), and any other programmatically accessible storage solutions, may be provisioned as the data store 502. Further, in some embodiments, multiple storage resources may be simultaneously available as data stores within service 500 such that the image server 408 may select a specific storage option based on the size, availability requirements, etc. of a system image. Accordingly, the data store 502 provides the image service 500 with redundant, scalable, and/or distributed storage for system images.

In satisfying a client request, the image server 408 may also access the registry store 504. The registry store 504 retains and publishes system image metadata corresponding to system images stored by the system 500 in the data store 502. In one embodiment, each system image managed by the service 500 includes at least the following metadata properties stored in the registry store 504: UUID, name, status of the image, disk format, container format, size, public availability, and user-defined properties. Additional and/or different metadata may be associated with system images in alternative embodiments. The registry store 504 includes a registry database 518 in which the metadata is stored. In one embodiment, the registry database 518 is a relational database such as MySQL, but, in other embodiments, it may be a non-relational structured data storage system like MongoDB, Apache Cassandra, or Redis. For standardized communication with the image server 408, the registry store 504 includes a registry API endpoint 520. The registry API endpoint 520 is a RESTful API that programmatically exposes the database functions to the image server 408 so that the API server may query, insert, and delete system image metadata upon receiving requests from clients. In one embodiment, the registry store 504 may be any public or private web service that exposes the RESTful API to the image server 408. In alternative embodiments, the registry store 502 may be implemented on a dedicated information processing system of may be a software component stored on a non-transitory computer-readable medium in the same information processing system as the image server 408.

In operation, clients 510a-n utilize the external API endpoint 506 exposed by the image server 408 to lookup, store, and retrieve system images managed by the VM image service 500. In the example embodiment described below, clients may issue HTTP GETs, PUTs, POSTs, and HEADs to communicate with the image server 408. For example, a client may issue a GET request to <API_server_URL>/images/ to retrieve the list of available public images managed by the image service 500. Upon receiving the GET request from the client, the API server sends a corresponding HTTP GET request to the registry store 504. In response, the registry store 504 queries the registry database 518 for all images with metadata indicating that they are public. The registry store 504 returns the image list to the image server 408 which forwards it on to the client. For each image in the returned list, the client may receive a JSON-encoded mapping containing the following information: URI, name, disk_format, container format, and size. As an another example, a client may retrieve a virtual machine image from the service 500 by sending a GET request to <API_server_URL>/images/<image_URI>. Upon receipt of the GET request, the API server 504 retrieves the system image data from the data store 502 by making an internal API call to one of the storage API endpoints 514a-n and also requests the metadata associated with the image from the registry store 504. The image server 408 returns the metadata to the client as a set of HTTP headers and the system image as data encoded into the response body. Further, to store a system image and metadata in the service 500, a client may issue a POST request to <API_server_URL>/images/ with the metadata in the HTTP header and the system image data in the body of the request. Upon receiving the POST request, the image server 408 issues a corresponding POST request to the registry API endpoint 520 to store the metadata in the registry database 518 and makes an internal API call to one of the storage API endpoints 514a-n to store the system image in the data store 502. It should be understood that the above is an example embodiment and communication via the API endpoints in the VM image service 500 may be implemented in various other manners, such as through non-RESTful HTTP interactions, RPC-style communications, internal function calls, shared memory communication, or other communication mechanisms.

Further, in some embodiments, the VM image service 500 may include security features such as an authentication manager to authenticate and manage user, account, role, project, group, quota, and security group information associated with the managed system images. For example, an authentication manager may filter every request received by the image server 408 to determine if the requesting client has permission to access specific system images. In some embodiments, Role-Based Access Control (RBAC) may be implemented in the context of the VM image service 500, whereby a user's roles defines the API commands that user may invoke. For example, certain API calls to the image server 408, such as POST requests, may be only associated with a specific subset of roles.

To the extent that some components described relative to the VM image service 500 are similar to components of the larger cloud computing system 110, those components may be shared between the cloud computing system and the VM image service, or they may be completely separate. Further, to the extent that “controllers,” “nodes,” “servers,” “managers,” “VMs,” or similar terms are described relative to the VM image service 500, those can be understood to comprise any of a single information processing device 210 as described relative to FIG. 2, multiple information processing devices 210, a single VM as described relative to FIG. 2, a group or cluster of VMs or information processing devices 310 as described relative to FIG. 3. These may run on a single machine or a group of machines, but logically work together to provide the described function within the system.

FIG. 6 is a functional block diagram of a peer-to-peer image service 600 according to various aspects of the current disclosure. Generally, the image service 600 is an IaaS-style cloud computing system that provides for registering, storing, and retrieving virtual machine images and associated metadata as described relative to FIG. 5. The service also provides peer-to-peer distribution of data including system images. In a preferred embodiment, the peer-to-peer image service 600 is deployed as a service resource 130 in the cloud computing system 110 (FIG. 1).

Peer-to-peer file sharing protocols (e.g., Bittorrent) are used to facilitate the rapid transfer of data or files over data networks to many recipients while minimizing the load on individual servers or systems. Such protocols generally operate by storing the entire file to be shared on multiple systems and/or servers, and allowing different portions of that file to be concurrently uploaded and/or downloaded to multiple devices (or “peers”). A user in possession of an entire file to be shared (a “seed”) typically generates a descriptor file (e.g., a “torrent” file) for the shared file, which is provided to peers requesting to download the shared file. The descriptor contains information on how to connect with the seed and information to verify the different portions of the shared file (e.g., a cryptographic hash). Once a particular portion of a file is downloaded by a peer, that peer may begin uploading that portion of the file to others, while concurrently downloading other portions of the file from other peers. A given peer continues the process of downloading portions of the file from peers and concurrently uploading portions of the file to peers until the entire file has been received at which point it may be reconstructed and stored in its entirety on that peer's system. Accordingly, transfer of files is facilitated because instead of having only a single source from which a given file may be downloaded at a given time, portions may be downloaded from multiple source peers concurrently. In turn, the source peers may be downloading and uploading other portions of the file while the original transfer is in progress. It is not necessary that any particular user have a complete copy of the file, provided each portion of the file is available on at least one peer. Thus, files are quickly and efficiently distributed among the network, and multiple users may download the file without overloading any particular peer's resources.

As shown in the illustrated embodiment of FIG. 6, the peer-to-peer service 600 comprises a component-based architecture that includes an image server 602 similar to image server 408 described relative to FIGS. 4 and 5 and a data store 502 and registry store 504 as described relative to FIG. 5. The service 600 may also include clients 610a-n substantially similar to those described relative to FIG. 5. The client systems 610 may incorporate a peer-to-peer client 608 (described in detail below) coupled to a peer-to-peer channel 614. This configuration provides an alternate (and, in many cases, faster and more efficient) mechanism by which to retrieve system images. The service may also include one or more non-client peer-to-peer hosts 604. As described in more detail below, non-client hosts 604 may download and provide system images but do not necessarily utilize the provided images to launch virtual machines.

In various embodiments, the image server 602 acts as a communication hub that routes system image requests and data between clients 610a-n, hosts 604, the data store 502, and the registry store 504. The server 602 may provide images and other data via a single-source interface, for example an API endpoint 506, and/or via a multiple-source interface, for example a peer-to-peer endpoint 606. To provide peer-to-peer functionality, the image server 602 includes a peer-to-peer client 608 that in turn may include the peer-to-peer endpoint 606. The peer-to-peer client 608 may support concurrent uploading and downloading and may also support uploading and downloading of a single file concurrently. In some embodiments, the peer-to-peer client 608 supports a Bittorrent protocol. In some embodiments, the peer-to-peer client 608 supports an alternative decentralized file transfer protocol. In order to provide a file according to certain peer-to-peer protocols, the peer-to-peer client 608 may index the file and create a corresponding peer-to-peer descriptor 611.

The peer-to-peer client 608 may make available all the images accessible by the image server 602 or a subset thereof. The determination of which images to offer may be based on any number of suitable criteria. Exemplary criteria include, and are not limited to, frequency of access, file access patterns, file modification patterns, other file history, network utilization, image server 602 load, client status, and client cache status. In an exemplary embodiment, images requested more often than a threshold frequency are made available over the peer-to-peer channel 614. In a related embodiment, images routinely requested at a particular time such as within a window of high network traffic are made available over the peer-to-peer channel 614. In another exemplary embodiment, the set of images offered via the peer-to-peer client 608 is determined based on the stability of the files that make up the image. Images that are frequently updated or that are frequently refreshed may be offered for peer-to-peer transfer. As another example, images that are stable and thus more commonly deployed may be offered via peer-to-peer. In yet another exemplary embodiment, the set of peer-to-peer images is populated based on image age. In a further exemplary embodiment, the images cached in the image server 602 such as within the server-side image cache 516 are included in the set of peer-to-peer available images. In some embodiments, images that are not cached in the image server 602 are included in the set of peer-to-peer images. An administrator may also designate images to include or exclude from the set of peer-to-peer images using inclusion and exclusion lists. In other various embodiments, the set is determined based on one or more of frequency of request, image stability, image age, cache status, administrator designation, other request considerations, and/or other suitable criteria.

As determining which images to offer via peer-to-peer transfer may depend on a record of past transactions, in some embodiments, the server 602 creates and maintains an image attribute log 612. In various embodiments, the image attribute log 612 includes a record of client requests, a record of images provided, a record of image attributes such as version, size, compile date, or peer-to-peer flags, and/or inclusion or exclusion lists modifiable by an administrator as well as any other relevant attribute known to one of skill in the art. In the illustrated embodiment, the image attribute log 612 is incorporated into the image server 602. However, in other embodiments, the image attribute log 612 is part of an external service.

To further improve performance and relieve burden from the server 602, the peer-to-peer service may include one or more non-client peer-to-peer hosts 604 capable of providing the image via a peer-to-peer channel 614, but which do not necessarily utilize the provided images to launch virtual machines. Instead, hosts 604 may be seeded to provide an additional peer for a peer-to-peer transfer. This may reduce the number of peer-to-peer requests arriving at the server 602. A host 604 may be implemented in software or in a tailored electrical circuit or as software instructions to be used in conjunction with a processor to create a hardware-software combination that implements the specific functionality described herein. To the extent that software is used to implement the host 604, it may include software that is stored on a non-transitory computer-readable medium in an information processing system, such as the information processing system 210 of FIG. 2. Hosts 604 may be substantially similar to image servers 602 and may be connected to one or more register servers 504 and data stores 502. In alternate embodiments, a host 604 is merely a peer-to-peer client 608 and a host image cache 616.

To seed the host 604, the image server 602 may provide the host 604 with an index of images to cache, the images themselves, and/or the associated image descriptors. The image server 602 may select the images to provide to the host 604 based on one or more image criteria such as client behavior, frequency of access, other access patterns, network considerations, image stability, image age, cache status, administrator designation, and/or other suitable criteria. As merely one example, an image server 602 may seed hosts 604 with images when the images are expected to be in high demand in the near future. In another example, an image server 602 seeds hosts 604 with an image when the number of requests for the image passes a threshold.

Upon receiving a request for an image from a client 610, the image server 602 may provide the image directly via the API endpoint 506 or instruct the client 610 to download the image via the peer-to-peer channel 614. If the image can be provided via the peer-to-peer channel 614, the server 602 may first provide the client 610 with the peer-to-peer descriptor corresponding to the requested image. In various embodiments, the descriptor is provided via any image server endpoint including the API endpoint 506 and the peer-to-peer endpoint 606. Once the descriptor is received, the client 610 can request and receive packets of the image from the server 602, from other clients 610, from designated peer-to-peer hosts 604, and/or from other devices connected to the peer-to-peer channel 614. In various embodiments, the ability of the client 610 to retrieve portions of the image from multiple sources improves download speed, relieves burden on the image server 602, and/or allows the client 610 to leverage advantageous network topography such as geographic proximity and location of a peer on a high-speed trunk or backbone. Furthermore, because of the peer-to-peer nature of the transfer, the client 610 may not be dependent on the server 602 after the descriptor is provided. The transfer can continue from other peers if, for example, the server 602 were to go offline. The result is that in many embodiments, the image transfer is faster, more resource efficient, and more resilient to disruptions than a single-source model.

FIG. 7 is a flowchart showing a method 700 of providing of an image based on a request received from a client according to various aspects of the current disclosure. The method is suitable for an image server 602 such as that described relative to FIG. 6. In block 702, a request is received from a client 610 for an image. In some embodiments, the request specifies the particular image to be provided. In alternate embodiments, the request contains information used to determine the image to be provided. Relevant information may pertain to the underlying hardware of the client 610, hardware to be emulated on the virtual machine, resources to be allocated to the virtual machine, resources accessible by the virtual machine, applications to be run on the virtual machine, the identity, class, or permissions of the user requesting the virtual machine, and/or other identifying information. In block 704, the requested image is identified. In block 706, it is determined whether the requested image is available for a peer-to-peer download. Images may be made available for peer-to-peer download based on any number of considerations, such as one or more of frequency of access, peak access times, temporal considerations, image stability, image age, cache status, administrator designation, and other suitable criteria. By way of non-limiting example, images that have been stable longer than a threshold time, images that are frequently accessed, images that are expected to be frequently accessed in the near future, and/or images that are new may be made available for peer-to-peer download. In some exemplary embodiments, the determination includes analysis of an image attribute log 612.

If the requested image is available for peer-to-peer download, the client may be notified in block 708. Notification may include setting an is_torrentable flag, providing a magnet uri, and/or providing a peer-to-peer descriptor corresponding to the image. In block 710, the image is transferred via a peer-to-peer channel 614. In some embodiments, the server 602 performing the notification may also act as a seed for the peer-to-peer download of the image. The server 602 may act as a seed for images stored at least in part on the server 602 such as in a server-side image cache 516. The server 602 may also act as a seed for images the server 602 has access to but that reside elsewhere such as in a registry store 504 or data store 502. For example, in an embodiment, the server 602 receives a request to transmit a portion of an image through the peer-to-peer endpoint 606. The server 602 determines that the requested portion resides in an object storage 512c in communication with the server 602. The server retrieves the requested portion via a SWIFT endpoint 514 and provides it through the peer-to-peer endpoint 606. Other embodiments retrieve the requested portion via other endpoints and/or via a server-side image cache 516. Further pass-through endpoints and storage locations are contemplated and provided for. In block 712, the image attribute log 612 may be updated with a record of the request and the status of the transfer such as complete, in progress, or halted.

Alternatively, if it is determined in block 708 that the requested image is not available for peer-to-peer download, the client may be notified in block 714. In block 716, the image may be provided by a single-source interface. In block 718, the image attribute log 612 may be updated with a record of the request and the status of the transfer such as complete, in progress, or halted.

FIG. 8 is a flowchart showing a method 800 of providing of a portion of a file as a virtual seed according to various aspects of the current disclosure. The method is suitable for an image server 602 such as that described relative to FIG. 6. In block 802, a request is received from a requestor such as an image server 602, a client 610, or a non-client host. The request specifies a portion of a file such as a system image and may be received via a multiple-source interface such as a peer-to-peer endpoint 606. In block 804, the location of the requested file portion is determined. For example, a file portion may be located within a local cache, a registry store, and/or a data store. In block 806, an interface or endpoint for retrieving the file portion is determined. The selected interface or endpoint may depend in part on the location of the requested file portion, the access speed and throughput of various available interfaces, network considerations, and/or other factors. In block 808, the file portion is retrieved via the selected interface. In block 810, the retrieved file portion is provided via a multiple-source interface such as a peer-to-peer endpoint 606.

This method provides pass-through functionality that allows a system such as an image server 602 to act as a virtual seed for a peer-to-peer transfer. In contrast to a typical peer-to-peer transfer, the provided file portion need not reside on the providing system. Instead, the system reaches through one or more of the other available interfaces, such as a file system endpoint 514a, a SWIFT endpoint 514c, and/or HTTP endpoint 514n, to retrieve the requested file portion. For example, in one embodiment, an image server 602 receives a request for a peer-to-peer transfer of an image that does not reside on the server-side image cache 516 of the server 602. The server 602 determines that the image resides within a SWIFT-based object store. The server 602 then determines that the optimal retrieval method for the file portion is via a SWIFT-based interface. The server 602 retrieves the file portion via the selected interface and provides it to the requestor via a peer-to-peer endpoint. Peer-to-peer pass-through may greatly increase the number of peer-to-peer requests that a system can satisfy and may increase the number of seeds on a network, thereby improving data transfer rates, data availability, and network resilience.

FIG. 9 is a flowchart showing a method 900 of preloading a file such as an image according to various aspects of the current disclosure. The method is suitable for an image server 602 such as that described relative to FIG. 6. Preloading distributes a file before the recipient initiates a transfer of the file. This is particularly useful for image files, which may entail substantial transfer times, and is particularly useful in a cloud environment, which may incur substantial penalties if an image is not available when a virtual machine is initializing. In order to avoid this delay, files may be preloaded into a cache of a receiving device before the receiving device initiates a transfer of the file.

In block 902, a cache of a receiving device is queried to determine a cache status. Examples of a cache include an image cache 412 as described relative to FIG. 4 when the receiving device is a client and a host image cache 616 as described relative to FIG. 6 when the receiving device is a non-client host. In some embodiments, preloading is performed when the cache status indicates an amount of free space greater than a predetermined threshold.

In block 904, a file is selected for preloading. The file may include a system image, and may be selected based on a status of the file, the recipient's cache status, the recipient's access pattern, access patterns of competing peers, availability of peers, network load, entries of an administrator specified list, and/or other suitable criteria. Files may also be selected through the use of inclusion and/or exclusion lists, which allow administrators to specify preload status.

In an exemplary embodiment, a file is selected for preloading if it has been stable for an amount of time greater than a predetermined threshold and thus is unlikely to be updated before it is used. In another exemplary embodiment, a file is selected for preloading if it includes an updated version of another commonly requested file. For example, a newly released version 1.1 of a file may be preloaded on devices that recently requested version 1.0 of the file. In another exemplary embodiment, files of greater than or less than a threshold size are selected for preloading.

In some exemplary embodiment, the selected file depends on the recipient's access pattern and/or access patterns of competing peers. In one such embodiment, the selection of a file depends on a request rate for the file being above a threshold. For example, if a system image receives more than 10 requests an hour, the file may be selected for preloading. In another such embodiment, a client routinely requests an image at a fixed time, such as a midnight refresh to capture the latest updates. In this example, to avoid a flood of clients stressing the network with requests around midnight, the server 602 preloads the image to one or more clients 610 ahead of time.

In block 906, a time is determined to provide the selected file for preloading. Similar to the determining the file, the determining of the time to provide the file may be based on the status of the file, the recipient's cache status, the recipient's access pattern, access patterns of competing peers, availability of peers, network load, entries of an administrator specified list, and/or other suitable criteria. In an exemplary embodiment, the time is selected to reduce concurrent transfers of data to a client and to a peer of the client. This may be determined based on a history of concurrent and competing data requests. Continuing the exemplary embodiment, both the client and a peer have a history of concurrent transfers of a data file at around midnight. Accordingly, a time is selected to preload the client before the midnight request of the peer.

In another exemplary embodiment, the time the image is scheduled to be preloaded depends on an attribute of the network. If the network experiences a period of low demand, the image may be provided during the lull. In another exemplary embodiment, the scheduled time depends on an administrator specified list. In this embodiment, a newly updated image is expected to experience heavy demand once it is announced. Prior to the announcement, an administrator modifies a list that instructs the server 602 to preload the image on a number of non-client hosts 604 prior to the official release. This ensures that more peers will be available to seed the clients 610 when release is official and the clients 610 are allowed to initiate requests. In another exemplary embodiment, the image server 602 distributes an image at a time corresponding to a particular state of a cache within a client 610. For example, if a client 610 routinely has an unused portion of an image cache 412 at a particular time of day, the preload may be scheduled accordingly.

In block 908, the providing server 602 distributes the selected data file to one or more designated recipients at the selected time. The recipients may be image servers 602, clients 610, non-client hosts 604, and/or other suitable computing devices. In many embodiments, the selected data file is provided through a peer-to-peer interface such as a peer-to-peer endpoint 606 of a peer-to-peer client 608.

Preloading may reduce network congestion and server thrash at critical times by pre-emptively supplying files before they are needed. Moreover, preloading via a peer-to-peer channel may have further benefits. Peer-to-peer transfers may reduce network impact and improve the speed of the preloading. Thus in some embodiments, more preloading may be performed in a peer-to-peer environment without taxing network and server resources when compared to single-source downloading. Furthermore, in some embodiments, the ability to preload non-client hosts 604 offers greater control over seed management. In one such embodiment, the method 900 preloads an image on a number of non-client hosts 604 prior to the official release. Thus more peers will be available to seed the clients 610 when release is official and the clients 610 are allowed to initiate requests. For at least these reasons, preloading of data files, including system images, alone or in conjunction with a peer-to-peer transfer mechanism facilitates rapid deploy of virtual machines in a cloud environment. Of course, these advantages are merely exemplary and no particular advantage is required for a particular embodiment.

Even though illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An image server comprising:
a peer-to-peer endpoint configured to receive a request for a portion of a data file from a requestor;
an endpoint communicatively coupled to a data store; and
a peer-to-peer client,
wherein the image server is configured to:
determine a location of the portion of the data file within the data store; and
retrieve the portion of the data file from the data store in response to the request for the portion; and
wherein the peer-to-peer client is configured to provide the retrieved portion of the data file to the requestor via the peer-to-peer endpoint.

2. The image server of claim 1, wherein the data file includes a system image.

3. The image server of claim 1 further comprising a server-side cache;
wherein the image server is further configured to:
in the determining of the location of the portion of the data file, determine the location of the portion within the data store and the server-side cache; and
in the retrieving of the portion of the data file, retrieve the portion from among the data store and the server-side cache.

4. The image server of claim 1, wherein the requestor includes a non-client host.

5. The image server of claim 4,
wherein the peer-to-peer interface is further configured to receive the request for the portion of the data file from the non-client host; and
wherein the peer-to-peer client is configured to provide the portion of the data file to the non-client host via the peer-to-peer interface.

6. The image server of claim 1,
wherein the endpoint includes a first endpoint communicatively coupled to a first storage of the data store;
the image server further comprising a second endpoint communicatively coupled to a second storage of the data store, the first endpoint being different from the second endpoint;
wherein the image server is further configured to determine a selected endpoint from the first and second endpoints for retrieving the portion of the data file from the data store; and
wherein the retrieving of the portion of the data file retrieves the portion of the data file via the selected endpoint.

7. A method for providing a data file, the method comprising:
receiving a request for a portion of a data file from a requestor;
determining a location of the portion of the data file on a data store in response to the received request;
determining an interface for accessing the portion of the data file;
retrieving the portion of the data file using the interface; and
providing the portion of the data file to the requestor via a peer-to-peer interface.

8. The method of claim 7, wherein the data file includes a system image.

9. The method of claim 7, wherein the requestor includes a non-client host.

10. The method of claim 7, wherein the determining of the location further determines the location of the portion of the data file on a server-side cache.

11. The method of claim 7, wherein the determining of the interface includes determining one of a first interface communicatively coupled with a first storage of the data store and a second interface communicatively coupled with a second storage of the data store, the first interface being different from the second interface.

12. A method for preloading a data file, the method comprising:
determining, by a providing server, a data file to provide via a peer-to-peer interface;
determining a time to provide the data file to a receiving system, the time being prior to the receiving system initiating a transfer of the data file; and
providing, by the providing server, the data file to a receiving system at the determined time via the peer-to-peer interface.

13. The method of claim 12 further comprising determining a cache status of the receiving system.

14. The method of claim 13, wherein the determining of the data file to provide determines based on the cache status of the receiving system.

15. The method of claim 13, wherein the determining of the time to provide the data file determines based on the cache status of the receiving system.

16. The method of claim 12, wherein the determining of the time to provide the data file determines based on a behavior of a peer of the receiving system.

17. The method of claim 16, wherein the behavior includes a prior transfer of data to the peer concurrent with a prior transfer of data to the receiving system.

18. The method of claim 12, wherein the determining of the time to provide the data file determines based on an attribute of a network communicatively coupling the providing server and the receiving system.
